(19) United States
(12) Patent Application Publication
(10) Pub. No.: US 2015/0278806 A1
(43) Pub. Date: Oct. 1, 2015

(54) E-PAYMENT ARCHITECTURE PRESERVING PRIVACY

(71) Applicants: BULL SAS, Les Clayes sous Bois (FR); LABORATOIRE CREYC, CAEN Cedex 4 (FR)

(72) Inventors: Aude Plateaux, Beuzeville (FR); Vincent Coquet, Croissy Sur Seine (FR); Sylvain Vernois, Mathieu (FR); Patrick Lacharme, Caen (FR); Christophe Rosenberger, Saint Laurent De Condel (FR)

(21) Appl. No.: 14/434,956

(22) PCT Filed: Oct. 11, 2013
(86) PCT No.: PCT/EP2013/071337

§ 371 Date: Apr. 10, 2015

Related U.S. Application Data
(60) Provisional application No. 61/712,616, filed on Oct. 11, 2012.

(51) Int. Cl. G06Q 20/38; G06Q 20/40

(52) U.S. Cl. CPC G06Q 20/383; G06Q 20/40

(57) ABSTRACT

A method for providing online electronic payment from a client (202) for a good or service provided by a service provider (204), includes:
receiving by the client a contract from the service provider containing at least a total amount of purchases;
requesting a voucher by the client to a client bank (206), by sending at least the total amount and a signature of the client;
the client bank generates the voucher, which includes at least the total amount and a certificate of the client bank, and sends it to the client;
relaying the voucher by the client and by the service provider to a service provider bank (210); and
after authentication of the voucher, the service provider bank transfers a credit validation, and the service provider delivers the good or service to the client.

### FIELD OF THE INVENTION

Embodiments relate generally to online electronic payments and, more particularly, to systems and methods providing online electronic payments for service and/or goods from a network device including, for example, an Internet terminal device, an Internet browser on a personal computer, an Internet browser on a TV, a mobile phone, and/or a tablet, such as an Apple iPad.

Some embodiments also relate to privacy of individuals and of e-payment SP (Service Providers).

Some embodiments also relate to Privacy of individuals and of m-payment SP.

### BACKGROUND OF THE INVENTION

Although SET was more respectful of privacy than 3D-Secure, this latter is often the favourite e-payment solution. Consequently, the 3D-Secure protocol is widely used on the web. It is developed by VISA and adds a step to the authentication of online payment.

Similarly, MasterCard offers the MasterCard SecureCode protocol.

FIG. 1 is an illustration of a 3D-Secure online e-payment architecture system studied by the inventors. The 3D -Secure protocol is composed of steps (labelled A-I in FIG. 1) which are exchanges between five actors.

At step A the client sends to the SP his purchase intention. The client provides his bank information: PAN (Personal Account Number—the embossed card number), expiry date, CVV2 (Card Verification Value—for example, the visual cryptogram at the back of the card).

At step B, to communicate with the VISA server, the SP has a VISA MPI (Merchant Plug In). MPI queries the VISA directory with the VEReq (Veryfy Enrollment request) message.

At step C the VISA server checks the SP, the card number and the client bank.

At step D, the message VERes (Verify Enrollment result) contains the response to the VEReq message. The ACS (Access Control Server) checks if the client's bank is enrolled in the 3D-Secure program and sends the URL to the merchant.

At step E, MPI sends the PAReq (Payer authentication request) message to the given

URL. This message contains the details of the authorised purchase. MPI also opens a client's pop-up window to the ACS.

At step F, the customer provides the necessary information for authentication from the bank.

At step G, ACS sends to MPI a confirmation of client's authentication using message through PARes message.

At step H, MPI records PARes message as confirmation of client's authentication by ACS.

At step I, SP authenticates to the bank. The bank verifies the nature of the transaction from the client's bank and confirms the payment authorization from the SP.

The SP then gets his payment. Moreover, the client's bank stores payment information to ensure non-repudiation of the transaction by the different parties.

Unfortunately, these services have flaws which affect the user's privacy. When the client moves to payment step, he enters sensitive banking data (card number, expiry date, visual cryptogram). Although this information is for the SP bank, it directly passes through the SP. Consequently, the 3D-secure protocol may not assure the privacy protection. For example, transaction and payment data may be exchanged in clear text between the actors (even if it may be ciphered during it transportation on the Internet):

The SP can easily store the client's banking data;

The client's bank knows the SP identity;

The SP knows the client's bank;

The SP bank knows the client.

Therefore, the actual online payment architectures do not enough preserve the privacy of users and SP.

### BRIEF DESCRIPTION OF THE DRAWINGS

FIG. 1 illustrates a 3D-Secure online e-payment architecture system studied by the inventors.

FIG. 2 illustrates an online e-payment architecture preserving privacy system.

FIG. 3 is a block diagram illustrating an online e-payment architecture preserving privacy system.

FIG. 4 is a flowchart showing an exemplary method for processing online electronic payments while preserving privacy.

FIG. 5 is a block diagram of an exemplary embodiment of an online e-payment architecture preserving privacy system.

### DETAILED DESCRIPTION

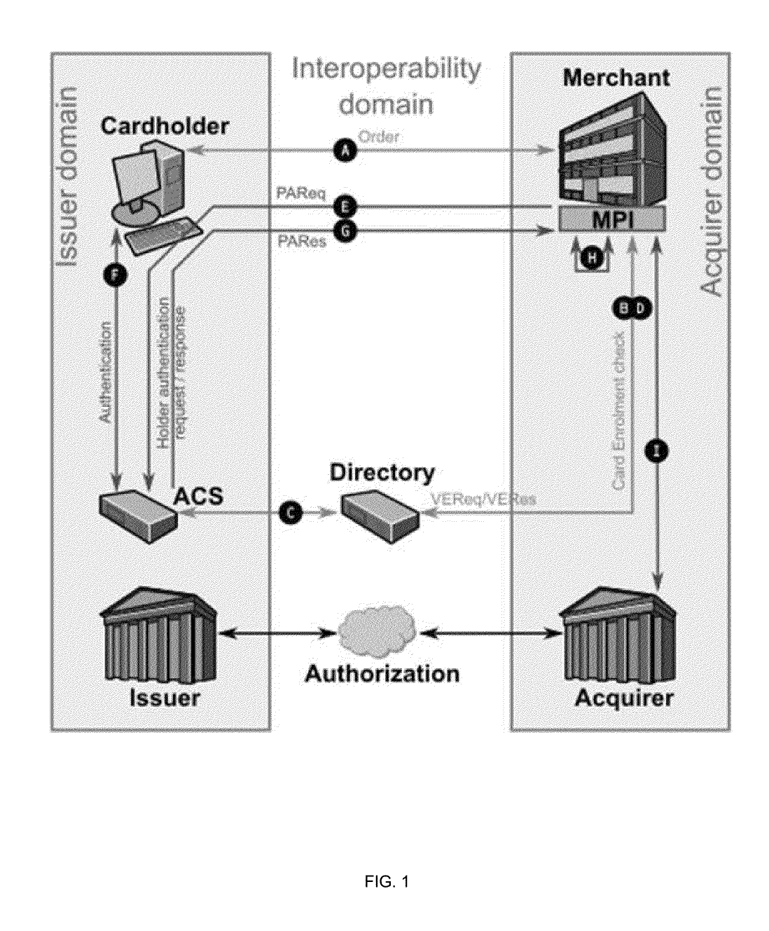

FIG. 1 illustrates a 3D-Secure online e-payment architecture system studied by the inventors, as described above.

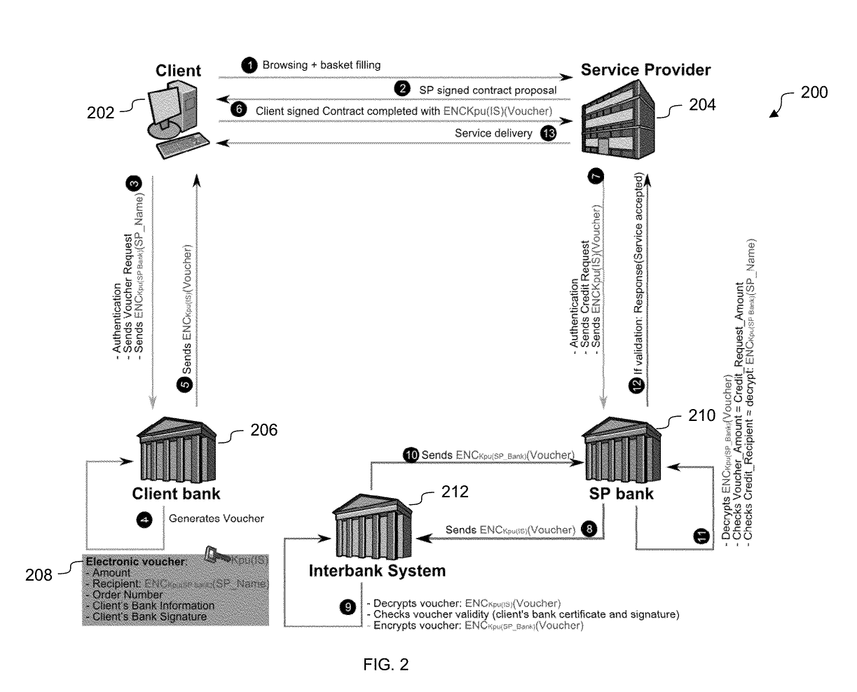

FIG. 2. Illustrates an online e-payment architecture preserving privacy system 200. In this infrastructure, five main actors are present:
The client C (202);
The service provider SP (204);
The client payment provider PPC (206), that is to say the debit account bank;
The SP payment provider PPSP (210), that is to say the credit account bank;
An interbank trusted third party (for instance: a payment scheme), also named interbank system IS (212) whose goal is detailed later.

The online e-payment architecture respecting the privacy of the users and SP is based on an electronic bank voucher, issued and signed by the client's bank and transmitted to the SP bank, encrypted by the public key of the IS or Intermediate Certification Authority used by the e-payment transaction.

This voucher is relayed by the client and the SP, so that neither the SP knows the client's bank, nor the client knows the SP bank.

The IS or Intermediate Certification Authority used all over the e-payment transaction is used by the SP bank to decrypts and re-encrypts the voucher, using respectively its private key and the public key of the SP bank.

The recipient's name (SP name) is not known by the IS or Intermediate Certification

Authority used by the e-payment transaction as it is encrypted with a randomly generated symmetric key—one per transaction—itself encrypted under the public key of the SP bank.

Each client and SP bank must have signed a contract with the same IS. Each one must have generated a key pair which public key is certified by the IS. This latter publishes these certificates. Client and SP banks may contract with more than one IS.

Every PPC and PPSP public key certificate can contain the following:
The PPC or PPSP bank name: BankC or BankSP respectively;
The PPC or PPSP bank public key: Kpublic(PPC) or Kpublic(PPSP) respectively;
The public key hash algorithm: SHA-1 for instance;
The signature algorithm: RSA for instance;
The universal identifier of the IS Certification Authority.

Similarly, each Client and SP must have signed a contract with their bank for the same IS. Each one must have generated or received a key pair which public key is certified by the corresponding IS or by an Intermediate Certification Authority of the IS. Each IS and Intermediate Certification Authority publishes the certificates it signed. Client and SP may contract with more than one banks, for one or more IS.

Every Client or SP public key certificate can contain the following:
The Client or SP name: Client1 or SP1, respectively;
The Client or SP public key: Kpublic(Client) or Kpublic(SP), respectively;
The public key hash algorithm: SHA-1 for instance;
The signature algorithm: RSA for instance;
The universal identifier of the IS Certification Authority or Intermediate Certification Authority.

In order to make easier the reading and interpretation of these certificates, they should be standardized (for instance: X.509).

However, some embodiments allow Clients and SP not to reveal the identity of their bank. Thus, in order to add privacy for Clients and SP, the generation of their certificate should not be by related to their bank, as Intermediate Certification Authority under the authority of the IS Certification Authority. A trusted party different from their bank is preferable. It's why the IS Intermediate Certification Authority should be an independent third trusted party, different from the Client, respectively, SP, bank.

The online payment phase can respect the customer's privacy and restrict the disclosure of personal information. Moreover, it can provide a better security for the transaction between the Client and the SP. The following describes this solution.

With regard to the payment phase, in the case where authentication and/or registration with the SP are required, it is assumed that it is properly conducted, without intrusion into Client's privacy. Indeed, a priority is to ensure SP to be paid and therefore have a secure payment protocol. SP has not to know other client's personal information.

This proposal is based on the generation of two documents:
A commercial contract signed between the SP and the Client;
An electronic bank voucher issued by the bank of the Client.

The IS can play a role of a trusted third party. It can enable communication between banks without revealing information about:
The end-to-end actors (point specific to this online payment architectures):
   The SP identity is not known from the Client's bank;
   The SP bank doesn't know the Client's identity;
   The Client's identity is not known from the SP bank;
   The Client's bank doesn't know the SP identity;
The nature of the contract signed by the Client (point specific to this online payment architectures), as a consequence of the previous points concerning the confidentiality of:
   The SP identity against the Client's bank;
   The Client's identity against the SP bank;
The details of the contract sealed between the SP and the Client (point common with other online payment architectures).

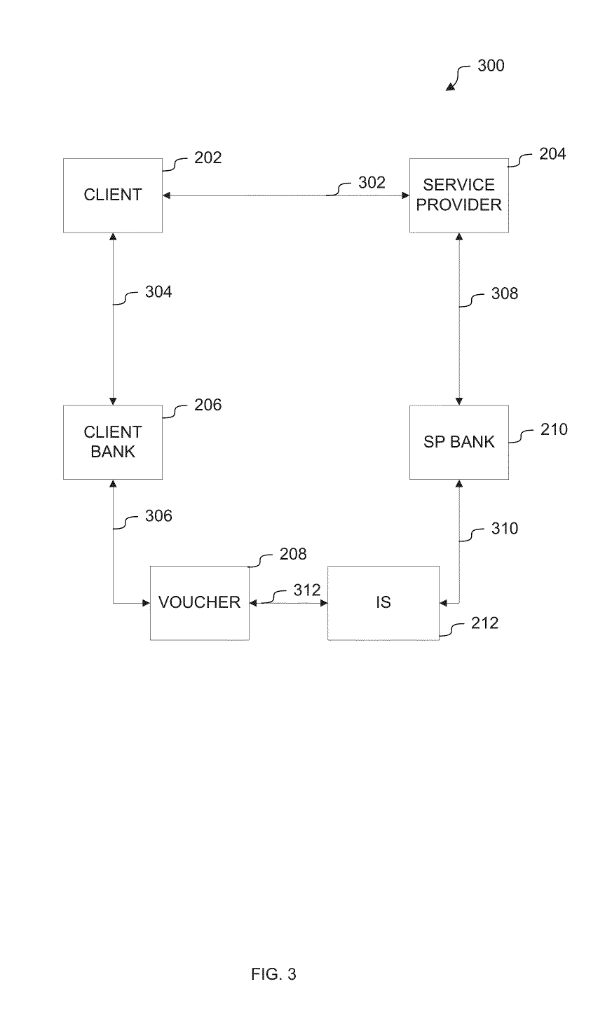

FIG. 3 is a block diagram illustrating an online e-payment architecture preserving privacy system 300. The system 300 can include a client 202, a service provider 204, a client bank 206 that can generate a voucher 208, an IS 212, and an SP bank 210, each corresponding to the similarly numbered items of FIG. 2 and described above.

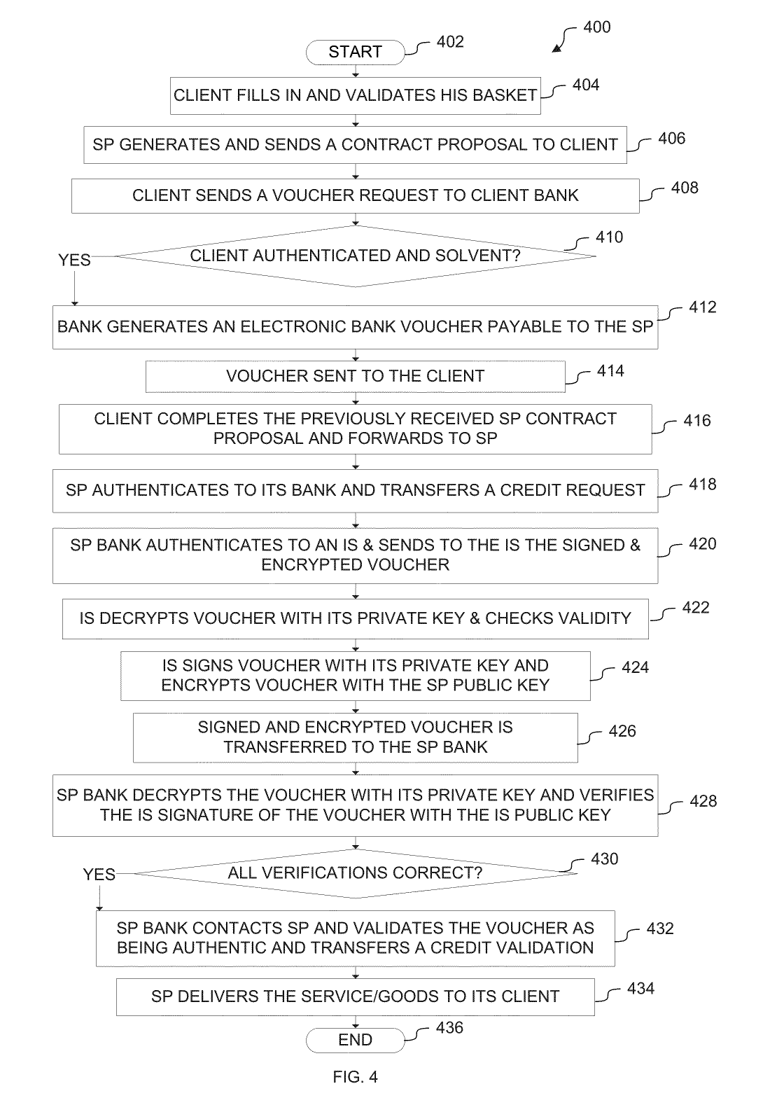

FIG. 4 is a flowchart showing an exemplary method 400 for processing online electronic payments while preserving privacy. Processing begins at 402 and continues to 404.

At 404, the client fills in and validates his basket. Processing continues to 406

At 406, the SP generates and signs a contract proposal containing:
The detailed shopping list of the transaction: item quantity, unit price, total price;
The total amount of purchases;
The currency;
A proposal number generated by the SP;
The SP public key certificate corresponding to the private key of signature and issued by the IS or an Intermediate Certification Authority of the IS;
The cryptogram of a randomly generated symmetric key—one per transaction—encrypted under the SP bank public key;
The name of the SP encrypted by the above symmetric key;
The SP signature of the contract.

To respect the client's privacy during the transfer of data to different banks, the proposal number has not to contain SP information, as the business number or name.

The contract is signed by the SP with the respect of legislation. The contract does not bind the customer to pay. It urges SP on to provide all items at indicated price to the customer if this latter pays.

This contract is sent to the client. Processing continues to 408.

At 408, the client connects to his bank, using, for example, a macro of its Internet browser for example, authenticating with the method and tools of its bank. For example, this macro can establish an HTTPS connection and send a voucher request to the client bank.

The voucher request contains the following necessary information for the client's bank; it is extracted from the contract proposal and of client's information:
The whole amount;
The currency;
The cryptogram of the symmetric key encrypted under the SP bank public key;
The name of the SP encrypted by the above symmetric key;
The proposal number generated by the SP;
The client's signature of the voucher request;
The client's public key certificate corresponding to the private key of signature and issued by the IS or an Intermediate Certification Authority of the IS.

The client adds the recipient's name for the future credit, that is to say the SP. However, the client's bank has not to know the SP identity. The name of the SP is encrypted.

The encrypted SP name allows the client's bank to insert the order of his future electronic bank voucher. Processing continues to 410.

At 410, if the client authentication is successful and the client is solvent, the bank positively responds to the client's request and processing continues to 412.

At 412, the bank generates an electronic bank voucher payable to the SP. This electronic voucher includes:
The total amount of the purchase;
The currency;
The name of the SP, encrypted by the SP bank public key (information extracted from the SP public key certificate);
The information of the client's bank;
The client's bank signature of the voucher;
The client's bank public key certificate corresponding to the private key of signature and issued by the IS or an Intermediate Certification Authority of the IS.

The client's bank encrypts the voucher with the public key of the IS or Intermediate Certification Authority pointed out by the client's public key certificate. Processing continues to 414.

At 414, the voucher is sent to the client. Processing continues to 416.

At 416, the client, for example via the client's browser macro, completes the previously received SP contract proposal with the following:
the signed and encrypted voucher;
its client's public key certificate, signed by the same IS or Intermediate Certification Authority as the one pointed out in the SP public key certificate;
a minimum of personal information, like majority—not age.

The client signs the whole before to forward it to the SP. The voucher being encrypted, the SP cannot know client's bank information. Processing continues to 418.

At 418, the SP authenticates to its bank and transfers to it a credit request composed of the following:
The whole amount;
The currency;
The proposal number generated by the SP;
The signed and encrypted electronic bank voucher.
The SP signature of the credit request;
The SP public key certificate corresponding to the private key of signature and issued by the IS or an Intermediate Certification Authority of the IS.

The SP bank is able to identify the SP. Indeed, the name of the SP, encrypted by the SP bank public key is included in the SP public key certificate. Processing continues to 420.

At 420, the SP bank authenticates to the IS or Intermediate Certification Authority of the IS pointed out in the SP public key certificate and transfers to it the signed and encrypted electronic bank voucher. Processing continues to 422.

At 422, the IS decrypts electronic voucher with its private key. It checks the validity of this voucher; therefore it verifies:
The certificate and identity of the client's bank;
The signature of the voucher.

Processing continues to 424.

At 424, the IS again signs the entire voucher, as defined at 412, using its private key; it encrypts it with the SP bank public key.

It will be appreciated that one or more of the operations may be done in an HSM (Hardware Security Module).

Processing continues to 426.

At 426, the signed and encrypted voucher is transferred to the SP bank. Processing continues to 428.

At 428, the SP bank decrypts the voucher with its private key and verifies the IS signature of the voucher with the IS public key.

It can be checked that the voucher amount and currency are similar to those provided by the SP in the credit request. Then, the bank can decrypt the recipient's name using its private key corresponding to the IS certifying the public key of the SP in the credit request. Processing continues to 430.

At 430, if all verifications are correct, processing continues to 432.

At 432, the SP bank contacts SP and validates the voucher as being authentic.

Then, the SP bank transfers a credit validation composed of the following:
The whole amount;
The currency;
The proposal number generated by the SP;
The signed and encrypted electronic bank voucher.
The signature of the SP bank;
The SP bank public key certificate corresponding to the private key of signature and issued by the IS or an Intermediate Certification Authority of the IS.

Processing continues to 434.

At 434, confident that the voucher is authentic, the SP delivers the service and/or goods to its client. The SP bank also joins the client's bank, located through the client's bank public key certificate contained in the electronic voucher. Processing continues to 436, where processing ends.

The debit-credit process between banks completes this payment architecture in respecting the client's privacy:
The SP bank encrypts the electronic voucher with the client's bank public key;
The SP bank sends this encrypted voucher;
The client's bank decrypts the voucher with its private key and checks it;
Both banks respectively carry the debit and credit of the account of the client and SP.

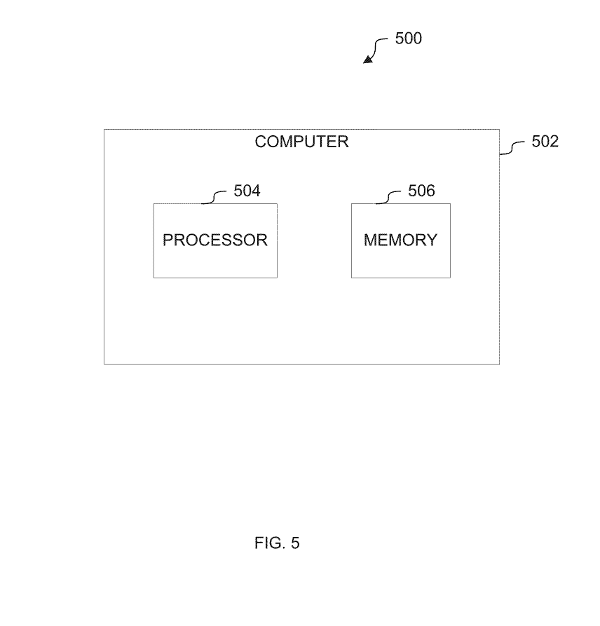

FIG. 5 is a block diagram of an exemplary embodiment of an online e-payment architecture preserving privacy system. System 500 can include a computer 502 that can include a processor 504 and a memory 506.

In operation, the processor 504 will execute instructions stored on the memory 506 that cause the computer 502 to perform one or more steps of the process shown in FIG. 4.

It will be appreciated that more than one computer 502 may be used to perform the steps shown in FIG. 4. For example, more than one 502 can be connected to each other via a network and each performing one or more steps of the process shown in FIG. 4.

It will be appreciated that the modules, processes, systems, and sections described above can be implemented in hardware, hardware programmed by software, software instructions stored on a nontransitory computer readable medium or a combination of the above. An online e-payment architecture preserving privacy system, for example, can include using a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, or another structured or object-oriented programming language. The sequence of programmed instructions and data associated therewith can be stored in a nontransitory computer-readable medium such as a computer memory or transponder device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the computer programming and postal address recognition arts.

Moreover, embodiments of the disclosed method, system, and computer program product can be implemented in software executed on a programmed general purpose computer, a special purpose computer, a microprocessor, or the like.

It is, therefore, apparent that there is provided, in accordance with the various embodiments disclosed herein, computer systems, methods and software for remote encoding center automation.

While the invention has been described in conjunction with a number of embodiments, it is evident that many alternatives, modifications and variations would be or are apparent to those of ordinary skill in the applicable arts. Accordingly, Applicants intend to embrace all such alternatives, modifications, equivalents and variations that are within the spirit and scope of the invention.

Data Security

Firstly, the authentication protocols and secure channel between actors ensure the security principle. It is also reinforced by the possession of Client, SP and banks certificates. The banks own certificates issued by the IS. The SP certificate is provided by IS or an intermediate certification authority which are not known by the Client or its bank as related to the SP bank. The Client's certificate is provided by IS or an intermediate certification authority which are not known by the SP or its bank as related to the Client's bank. These documents allow to sign, encrypt and decrypt information and to prove the validity of the Client, SP and banks. Thus, contrary to the SET protocol, the trusted third part is not one of the banks.

Then, the transferred data are always encrypted using asymmetric protocols through a secure channel. Consequently, the confidentiality and the integrity are always respected.

Moreover, the IS manages the bank certificates. Consequently, it checks information contained in the signed electronic voucher and gives a validation of voucher for the SP bank. Thus, validation of the client's bank identity by the IS and verification of transaction information by the SP bank assure the SP to be paid once the service provided.

Finally, the signed contract by the SP allows client to obtain his service with indicated conditions.

Principles of Privacy

Firstly, the client's personal data and these intentions are heavily protected. Indeed, the client can be configured so that it does not provides personal data to the SP even when the client is certain to use a service and pays for it.

Then, our architecture is more respectful of the users' privacy than the SET protocol and 3D-Secure protocol. Thanks to filtered contract, encrypted recipient name and random order number, the client's bank knows neither contents of the basket, nor the SP with whom his client is dealing with. Moreover, in some embodiments, the client's identity is not disclosed to the SP. Consequently, the SP bank does not know the customer.

In addition, this new proposition solves the others privacy problems of 3D-Secure protocol. Indeed, the client's personal information is preserved against the SP. The encrypted voucher with private key of the IS allows the SP not to have knowledge of the client's bank.

Moreover, the client's banking information is not disclosed to the SP. Thus, the most sensitive data of customer are protected.

Thus, the client only provides the necessary, appropriate and relevant information. The minimization and sensitivity principle are ensured. The sovereignty principle is also guaranteed thanks to the electronic signature for validation of the contract by the SP and the client.

Finally, the voucher encrypted with the IS public key prevents the client to know the SP bank. Consequently, the protection of some SP personal information is also assured.

| Properties | New architecture | 3D-Secure | SET |
|---|---|---|---|
| Minimization principle | ⋆⋆⋆ | ⋆ | |
| Sovereignty principle | ⋆⋆ | | |
| Sensibility principle | ⋆⋆⋆ | ⋆⋆ | |
| Security principle | X | X | X |
| Confidentiality | X | X | X |
| Integrity | X | X | X |
| Anonymity | X | | |
| Pseudonymity | X | | |
| Authentication | X | X | X |

### The Analysis of the New e-Payment Architecture

In other embodiments, Signature, when used, may be with or without data retrieval.

In other embodiments, the client certificate may be directly present in the client's identity card or his IAS passport.

In other embodiments, the initial contract proposal may be done by the SP or by the client, changing the cinematic and content of the exchanges and protocols.

In other embodiments, encryption by public key may be replaced by encryption by a symmetric key, which is added to the protocol message information, encrypted by the public key.

In some embodiments, A Google like bar may be added to the client Internet browser.

It allows through a button to activate an application (instead of a macro) responsible for:
Building up the filtered information from the commercial proposal between the SP and the client;
Connecting to the client bank, using the usual authentication mechanism of the home banking application;
Sending the voucher request;
Waiting for the voucher;
Wrapping the voucher with the contract.

Then the client signs the contract and sends it back with the voucher to the SP.

In some embodiments, The IS or Intermediate Certification Authority involved in one online e-payment transaction may be unique or in the same chain of certification or in different IS systems.

Thus, has been shown an e-payment systems and method for online electronic payments in which data privacy is preserved.

1. Method for providing online electronic payment from a client (202) for a good or service provided by a service provider (204), comprising steps of
Receiving by said client a contract from said service provider containing at least a total amount of purchases;
Requesting a voucher by said client to a client bank (206), by sending at least said total amount and a signature of said client;
Said client bank generates said voucher, which includes at least said total amount and a certificate of said client bank, and sends it to said client;
Relaying said voucher by said client and by said service provider to a service provider bank (210)
After authentication of said voucher, said service provider bank transfers a credit validation, and said service provider delivers said good or service to said client.
